(19) United States
(12) Patent Application Publication
(10) Pub. No.: US 2004/0041564 A1
(43) Pub. Date: Mar. 4, 2004

(54) System and method for improving indoor air quality

(76) Inventor: Richard Brown, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 10/234,055

(22) Filed: Sep. 3, 2002

(51) Int. Cl. G01V 3/00

(52) U.S. Cl. 324/318; 324/322

(57) ABSTRACT

A method for improving air quality in a human dwelling may include irradiating a portion of air flowing through an airflow conduit with ultraviolet light. The method may include turbulating, filtering, and/or adjusting a humidity of at least a portion of the air. The method may include creating an air pressure within the dwelling that exceeds an air pressure outside of the dwelling and/or monitoring air quality of at least a portion of the air. A system for improving air quality of air flowing through an airflow conduit may include an ultraviolet light source, a humidity control unit, a turbulator, and/or a filter. The system may include a blower and/or a ventilator. The system may include a sensor and/or a monitor for transmitting air quality characteristics to a remote site.

### BACKGROUND

1. Field of the Invention

The present invention generally relates to improving indoor air quality in a human dwelling. Embodiments of the invention relate to the removal of mold, bacteria, and other contaminants from a human dwelling.

2. Description of Related Art

Concerns about the effects of indoor air quality on human health have increased in recent years. As information about the health risks related to exposure to various types of contaminants becomes available, interest in maintaining a healthy indoor environment has expanded to include residential settings. In particular, the presence of certain molds in homes has been shown to cause long-lasting and far-reaching health problems, some of which may be fatal. Consequently, prevention and treatment of indoor contaminants is of interest to the healthcare and insurance industries as well as individuals.

Various methods of indoor air treatment have been implemented. These methods include stand-alone units as well as devices designed for integration with central air treatment systems, such as heating, ventilation, and air conditioning (HVAC) systems. Radiation sources such as ultraviolet lamps have been used in portable air purification devices. Radiation sources have also been used in conjunction with HVAC systems to inhibit growth of bacteria and certain molds on condensing coils and/or drain pans. Filtering devices such as activated carbon filters, high energy particulate air (HEPA) filters, and electrostatic filters have been used to remove particulate matter and pollutants from indoor air. Creating a positive pressure in a room has been shown to create a “tight room” or “clean room” effect, and certain airflow characteristics are known to enhance air cleaning capability. In addition, sensors have been used to detect characteristics such as airflow, humidity, and ozone levels.

### SUMMARY

A method for improving air quality in a human dwelling may include purifying, filtering, and/or conditioning indoor air to remove contaminants including, but not limited to, microorganisms, particulate matter, and pollutants. Improving air quality in a dwelling may include treating air in an airflow conduit coupled to an air treatment system.

Purifying air in an airflow conduit may include radiating at least a portion of the air with ultraviolet light. In an embodiment, indoor air quality may be increased by irradiating one or more components of an air treatment system, such as a condensing coil or a drain pan in an air conditioning system. The ultraviolet radiation used may be short-wave ultraviolet radiation, with a wavelength ranging from about 200 nanometers to about 280 nanometers. In an embodiment, a reflective cavity or conduit may be used to allow the radiation to interact more uniformly with contaminants in a portion of air. In an embodiment, turbulating air in an airflow conduit may change a direction of airflow and/or slow down movement of air through the conduit. Turbulating air in an airflow conduit may increase an interaction time between a radiation source and a portion of air in an airflow conduit, thus enhancing contaminant removal from the portion of air.

In an embodiment, one or more filters may be used to remove particulate matter from at least a portion of air flowing through an airflow conduit. Filters used may include, but are not limited to, mechanical filters, electrostatic filters, absorption filters, and combinations thereof. In an embodiment, air flowing through an airflow conduit may be filtered prior to purification and/or conditioning. Alternatively, air flowing through an airflow conduit may be filtered subsequent to purification and/or conditioning.

In an embodiment, air flowing through an airflow conduit may be conditioned with at least one humidity control unit (i.e., humidifier or dehumidifier). A humidity control unit may be used to adjust a humidity level of at least a portion of air flowing through the airflow conduit. Decreasing the humidity of air in a human dwelling may decrease proliferation of mold in the dwelling. In an embodiment, moisture may be added to air that is too dry to increase a comfort level of the dwelling.

In an embodiment, a blower may be coupled to transfer air to an airflow conduit to raise an air pressure in the dwelling above an air pressure outside the dwelling. Creating a positive pressure in the dwelling relative to an exterior of the dwelling may inhibit outdoor contaminants from entering the dwelling. In an embodiment, air leakage from the dwelling may be inhibited by sealing leaks around windows, doors, and/or other openings in the dwelling. In an embodiment, a damper may be placed on an air inlet and/or air exhaust duct. In an embodiment, a blower may be part of a ventilator used for air exchange.

In an embodiment, sensors may be used to monitor air quality characteristics and/or equipment status. Air quality characteristics monitored may include, but are not limited to, airflow, temperature, humidity, and contaminant levels. Equipment parameters monitored may include, but are not limited to, filter performance and ultraviolet lamp performance. If an irregularity is noted, a monitoring system may automatically notify a service provider.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic of an embodiment of a turbulator and a UV source in an airflow conduit.

FIG. 2 depicts a schematic of an embodiment of a filter and a UV source in an airflow conduit.

FIG. 3 depicts a schematic of an embodiment of a UV source and three filters in an airflow conduit.

FIG. 4 depicts a schematic of an embodiment of a turbulator, a UV source, and two filters in an airflow conduit.

FIG. 5 depicts a schematic of an embodiment of a cleaning unit in an airflow conduit.

FIG. 6 depicts a schematic of an embodiment of a cleaning unit and a humidity control unit in an airflow conduit.

FIG. 7 depicts a schematic of an embodiment of a blower and a cleaning unit in an airflow conduit.

FIG. 8 depicts a schematic of an embodiment in which an air quality characteristic is monitored.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF EMBODIMENTS

Biological contaminants such as viruses, bacteria, and molds may build up in a human dwelling. These microorganisms, and the toxins they produce, may have a negative impact on human health. Indoor air quality may be improved by treating air as it flows through an airflow conduit. Methods of treating air, including irradiating, filtering, reflecting, turbulating, and humidifying/dehumidifying, and are known to improve indoor air quality. Creating positive indoor air pressure and/or monitoring air characteristics, such as temperature, humidity, and/or contaminant levels, may increase the effectiveness of a system designed to improve indoor air quality.

Indoor air quality may be improved by equipment designed to purify, filter, and/or condition air in conjunction with conventional air treatment systems. Conventional air treatment systems may include, but are not limited to, heating units, cooling units, heat/energy recovery ventilating units, and combinations thereof. Manufacturers such as Bryant (Indianapolis, Ind.), Carrier (Farmington, Conn.), Lennox (Richardson, Tex.), Ruud (Fort Smith, Ark.), and Trane (La Crosse, Wis.) produce units for heating, cooling, and/or ventilating human dwellings.

Separate units designed to purify, filter, and/or condition air in conjunction with conventional air treatment systems may be placed within an airflow conduit in a dwelling. Alternatively, a single unit designed to purify, filter, and/or condition air may be placed within an airflow conduit in a dwelling. Other units designed to purify, filter, and/or condition air may be placed within or proximate to conventional air treatment systems.

Ultraviolet (UV) radiation is known to kill certain molds and airborne and surface bacteria. U.S. Patent Application Publication No. 2002/0008214 of Sevack et al. entitled “ULTRA-VIOLET LAMP AND REFLECTOR/SHIELD ASSEMBLY,” which is incorporated by reference as if fully set forth herein, describes a UV lamp and reflector/shield assembly for mounting in a commercial HVAC system. U.S. Patent Application Publication No. 2002/0020297 of Harris et al. entitled “METHOD AND DEVICE FOR AIR PURIFICATION,” which is incorporated by reference as if fully set forth herein, describes a radiation source disposed along an air cleaning path. U.S. Pat. No. 5,817,276 issued to Fencl et al. entitled “METHOD OF UV DISTRIBUTION IN AN AIR HANDLING SYSTEM,” which is incorporated by reference as if fully set forth herein, describes a method for subjecting an HVAC system coil and drain pan components to short-wave UV radiation (UVC). Short-wave UV radiation (200-280 nanometers) is known to effectively eliminate a wide range of microorganisms.

UV devices designed to fit in existing HVAC systems are sold by various manufacturers. Sterile-Aire (City of Industry, Calif.) markets UV lights for HVAC applications. Ultravation (Brandon, Vt.) manufactures residential and commercial UV air disinfection equipment for installation in central heating or HVAC systems. Honeywell (Golden Valley, Minn.) sells UV air treatment systems designed to kill mold and airborne germs in HVAC systems. The Dual Lamp Ultraviolet Air Treatment System (Honeywell) and the Single Lamp Ultraviolet Air Treatment System (Honeywell) mount on a return air side of a HVAC system. These lamps kill a large percentage of bacteria passing by the lamps. The Coil Ultraviolet Air Treatment System (Honeywell) mounts in or above a condensing coil on a supply side of an air conditioning system and kills mold on system cooling coils. Enhanced performance may be achieved by using two or more such UV devices to improve indoor air quality.

The ability of UVC radiation to destroy microorganisms may be increased by increasing an intensity of the UV source. A greater UV intensity may be achieved by containing UV radiation in a reflective cavity. Reflectance may be increased within an HVAC system by lining or coating an inside surface of an airflow conduit with a reflective material. In an embodiment, an interior surface of an airflow conduit may be painted with aluminum paint. In another embodiment, an interior surface of an airflow conduit may be lined with aluminum foil or sheeting. Alternatively, a UV unit may be equipped with a reflector/shield assembly, such as the reflector/shield assembly described by Sevack et al. in U.S. Patent Application Publication No. 2002/0008214.

The ability of UVC radiation to destroy microorganisms may be increased by lengthening the time the microorganisms are exposed to the radiation. An air turbulator may be used to slow air speed and thus lengthen the amount of time a portion of air spends in a vicinity of a radiation source. A turbulator may slow air speed by mixing air around the radiation source and changing airflow direction, thus increasing a length of time contaminants are suspended in front of the radiation source. U.S. Pat. No. 4,184,538 to Rauenhorst entitled “VENTILATING HEAT EXCHANGER FOR BARNS,” which is incorporated by reference as if fully set forth here, describes the use of turbulator bars in air ducts. Sanuvox Technologies Inc. (Montreal, Quebec) manufactures an air purification unit (Sanuvox R3500X) designed to purify a portion of air moving within an air duct. Contaminated air flows into the Sanuvox R3500X through an air turbulator. The air, slowed by the turbulator, then travels through an aluminum reflector tube that houses a UVC lamp. The purified air then flows out of the Sanuvox R3500X and reenters the air duct.

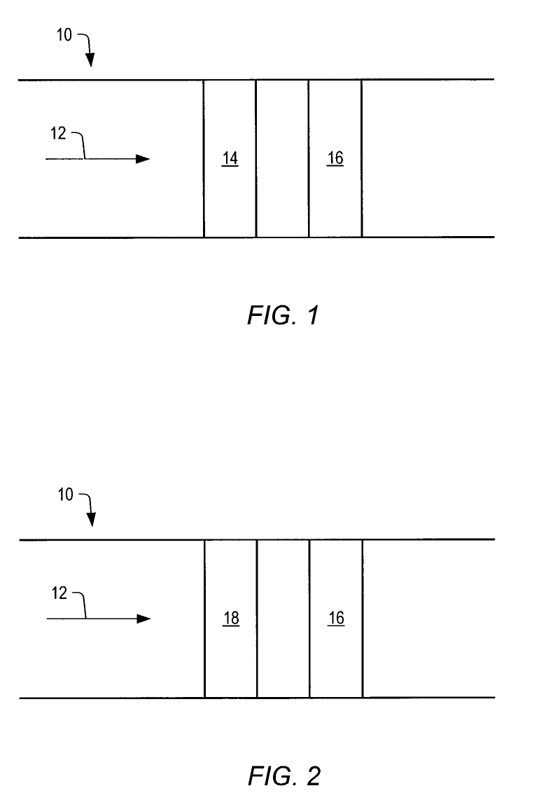

FIG. 1 depicts a schematic of an embodiment in which air flowing through airflow conduit 10 flows in direction 12 through turbulator 14. After flowing through turbulator 14, air flowing through conduit 10 is irradiated by UV radiation source 16. In an embodiment, the air may be irradiated by UV radiation source 16 before flowing through turbulator 14.

Indoor air may be filtered to remove contaminants. In an embodiment, filtering may precede and/or follow purification in an airflow conduit. Filters used to remove contaminants from indoor air may include, but are not limited to, mechanical filters, electrostatic filters, absorption filters, and combinations thereof.

Mechanical filters may include a membrane or layer made of materials including, but not limited to, paper, cloth, glass wool, other fibrous material, or a combination thereof. In an embodiment, filter membranes may be pleated. Mechanical filters may entrain particulate matter in air onto the membrane or layer. A membrane or layer of a mechanical filter may be treated or coated with a substance designed to enhance entrainment of particulate matter. A mechanical filter may be, for example, a high efficiency particulate air (HEPA) filter or a glass wool prefilter. In an embodiment, electrostatic filters may use an electrical potential between plates to remove charged contaminants from air. An absorption filter may chemically absorb airborne contaminants. In some embodiments, an absorption filter may include materials such as, but not limited to, activated carbon and/or zeolites. In some embodiments, activated carbon beds and/or high efficiency gas absorption (HEGA) filters may be used as absorption filters.

One or more filters may be used to filter air flowing through a dwelling. Different types of filters may be used separately or in combination to enhance air purification. For example, air in an airflow conduit may pass through a mechanical prefilter designed to collect relatively large airborne particles before passing through one or more filters including an electrostatic filter, an absorption filter, and/or another mechanical filter.

U.S. Pat. No. 6,289,974 issued to DeGregoria et al. entitled “INTEGRATED HEAT RECOVERY VENTILATOR HEPA FILTER USING A HEPA FILTER MATERIAL REGENERATIVE HEAT EXCHANGER,” which is incorporated by reference as if fully set forth herein, describes the use of a pleated HEPA filter material as a regenerative heat exchanger. Honeywell manufactures a high efficiency Electronic Air Cleaner (F300) with a HEPA filter to be mounted in the return air duct of a forced air heating, cooling, or ventilating system. The F300 Air Cleaner includes a prefilter to collect large dirt particles.

FIG. 2 depicts a schematic of an embodiment in which air in airflow conduit 10 flows 12 through filter 18 before flowing through UV source 16. Filter 18 may be a mechanical filter, an electrostatic filter, or an absorption filter. In certain embodiments, a turbulator may be positioned in airflow conduit 10.

In an embodiment, more than one filter may be positioned in airflow conduit 10. The filters may be located proximate each other or in different regions of airflow conduit 10. In an embodiment including two or more filters, at least one filter may be an electrostatic filter, while another filter may be an absorption filter or a mechanical filter.

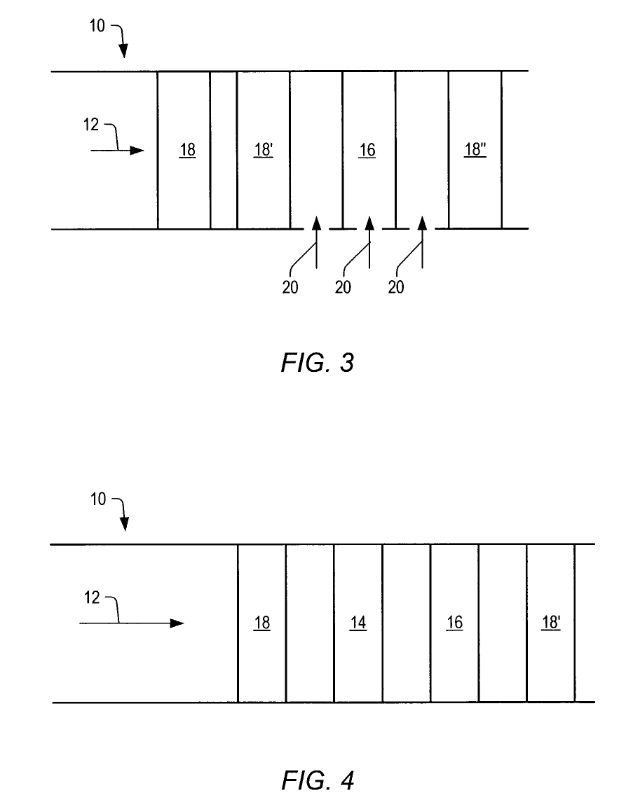

FIG. 3 depicts a schematic of an embodiment in which three filters are positioned in airflow conduit 10. Air in airflow conduit 10 flows 12 through filter 18 and filter 18′ before flowing through UV source 16. Filter 18 may be a mechanical prefilter for removal of relatively large particulate matter. Filter 18′ may be an electrostatic filter or a HEPA filter. Air may flow 20 into airflow conduit 10 in a region of the conduit between filter 18′ and filter 18″. Air in airflow conduit 10 in the region between filter 18′ and filter 18″ may be treated with light from UV source 16 before flowing through filter 18″. Filter 18″ may be an electrostatic filter or a HEPA filter. In an embodiment, filter 18′ is an electrostatic filter and filter 18″ is a HEPA filter. In an alternative embodiment, filter 18′ is a HEPA filter and filter 18″ is an electrostatic filter.

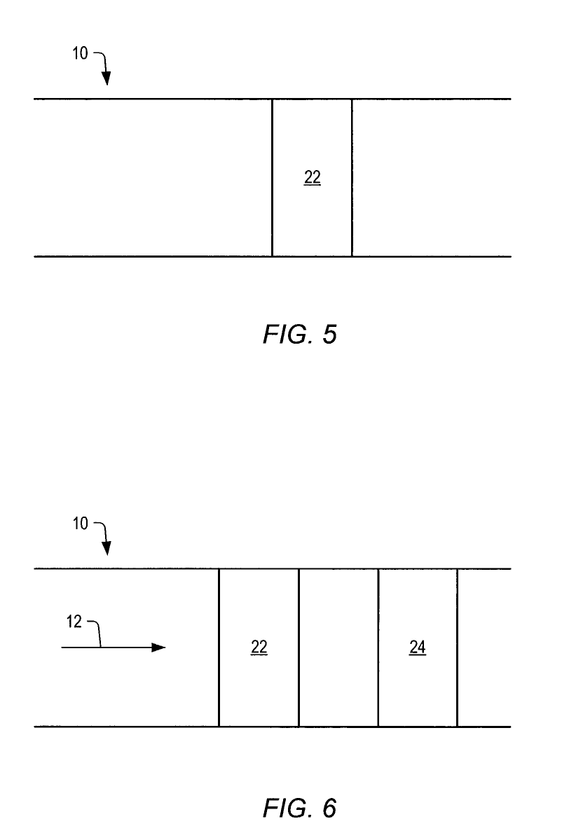

FIG. 4 depicts a schematic of an embodiment in which air in airflow conduit 10 may flow 12 through turbulator 14 after flowing through filter 18. After flowing through turbulator 14, the filtered air may flow through UV source 16 before flowing through filter 18′. FIG. 5 depicts a schematic of an embodiment in which at least one filter, a turbulator, and a UV source are housed together in cleaning unit 22 in airflow conduit 10.

Humidity in a dwelling may be controlled with a humidity control unit (i.e., humidifier and/or dehumidifier) installed in an airflow conduit. Dehumidification of indoor air may inhibit condensation in the dwelling, thereby reducing deterioration of building materials. Dehumidification may also reduce growth of bacteria, mold, and mildew in the dwelling as well as in the airflow conduit and/or air treatment system. U.S. Pat. No. 5,598,715 issued to Edmisten entitled “CENTRAL AIR HANDLING AND CONDITIONING APPARATUS INCLUDING BY-PASS DEHUMIDIFIER,” which is incorporated by reference as if fully set forth herein, describes conventional air circulating and air conditioning means used with dehumidification means for regulating the relative humidity of indoor air. Universal DryTop, a dehumidifier manufactured by DryKor (Fayetteville, Ga.) may be used in conjunction with an HVAC system. Universal DryTop also acts as a filter to remove some microorganisms and airborne bacteria as well as some particles larger than 5 microns in diameter.

A humidifier may be used in conjunction with an air treatment system to increase the humidity of air in a dwelling. U.S. Pat. No. 6,085,834 issued to Thomas et al. entitled “AIR HANDLING SYSTEM,” which is incorporated by reference as if fully set forth herein, describes the use of an evaporative humidifier. Honeywell manufactures several types of humidifiers for use with HVAC systems, including drum humidifiers, bypass flow through humidifiers, powered flow through humidifiers, and steam humidifiers. Bryant also manufactures humidifiers for use with HVAC systems, including fan powered flow through humidifiers and motorless by-pass humidifiers.

FIG. 6 depicts a schematic of an embodiment in which air flowing in direction 12 through airflow conduit 10 flows through cleaning unit 22 before flowing through at least one humidity control unit 24. Cleaning unit 22 may include at least one filter, a turbulator, and/or a UV source. Humidity control unit 24 may be a humidifier or a dehumidifier. In an embodiment, more than one humidity control unit 24 may be placed in airflow conduit 10. For example, air may flow through a humidifier and a dehumidifier located in different regions of airflow conduit 10.

Indoor air quality may be improved by removing contaminants that proliferate indoors and/or decreasing a rate at which contaminants from outdoors flow into a dwelling. Creating and maintaining a positive air pressure (i.e., an air pressure within the dwelling that exceeds an air pressure outside the dwelling) may inhibit a flow of contaminants into the dwelling. Indoor air quality may be more easily maintained in a dwelling with a positive air pressure. U.S. Pat. No. 6,289,974 to DeGregoria et al. describes positively pressurizing a leaky room to create a clean room effect.

Creating a clean room effect in a dwelling may involve coupling a blower to airflow conduit to increase a flow of outside air into the dwelling. A ventilator, such as an energy recovery ventilator or a heat recovery ventilator, may be used to increase airflow into a dwelling. Maintaining a clean room effect in a dwelling may involve sealing cracks around windows and doors and other openings in the dwelling, as well as placing dampers on air supply and exhaust ducts.

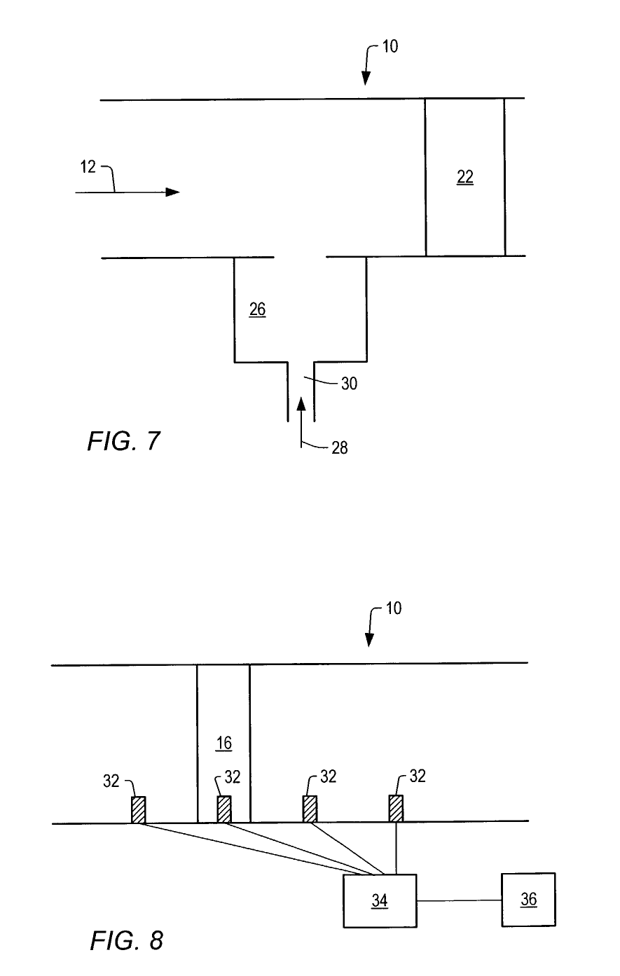

FIG. 7 depicts an embodiment in which blower 26 draws outside air 28 in through conduit 30 and blows the outside air into conduit 10. Air flowing through conduit 10 in direction 12 may force outside air 28 through cleaning unit 22. Cleaning unit 22 may include one or more filters, a turbulator, a UV source, and/or one or more humidity control units. Alternatively, a filter, a turbulator, a UV source, and/or one or more humidity control units may be housed separately in conduit 10. A rate at which outside air 28 flows into a dwelling may exceed a rate at which air flows out of the dwelling, thus creating a positive air pressure within the dwelling.

In an embodiment, various indoor air quality characteristics may be monitored to ensure that an air cleaning system is operating in a desired manner. U.S. Patent Application Publication No. 2002/0014401 of Fleischer describes a method and device for the treatment of air of at least one room by air ionization that includes a first air quality sensor, an airflow sensor, an air humidity sensor, an ozone sensor, and a second air quality sensor. An electronic control device is operatively connected via signal lines to the sensors.

Equipment status, such as filter performance and UV light performance, may also be monitored. Filter performance may be monitored by an instrument such as Filtrometer, manufactured by Precision Air Technology (Kirkland, Wash.). UVS Series air disinfection systems manufactured by UV Air Solutions (Brandon, Vt.) include a lamp monitor that signals when the UV lamp is nearing its replacement time and when the lamp has gone out. Guardtek (Tampa, Fla.) manufactures Service Guardian™, a wireless, electronic air conditioning and HVAC monitoring and reporting system. Service Guardian™ measures duct airflow, pan water level, mode, run time, interior temperature, and humidity. Service Guardian™ features a wireless link between the HVAC monitor (at an air handler) and a modem (mounted inside, near a phone jack). If an irregularity occurs, a service provider may be automatically notified.

FIG. 8 depicts a schematic of an embodiment of sensors 32 in conduit 10. In an embodiment, a sensor may be located within a unit, such as UV radiation source 16. Sensors 32 may measure air quality characteristics including, but not limited to, airflow, temperature, humidity, and contaminant level. In an embodiment, sensors 32 may indicate equipment status. For example, a sensor may detect when a filter or UV lamp needs to be replaced. Sensors 32 may be coupled to monitor 34. Monitor 34 may be located in an accessible location in a dwelling. Monitor 34 may display a visual indication of indoor air quality or equipment status. In an embodiment, monitor 34 may be coupled with an existing HVAC system. In an embodiment, monitor 34 may be coupled to transmission device 36 that allows air quality characteristics and/or equipment status to be transmitted to a remote site. In an embodiment, transmission device 36 may be a modem. Transmission of air quality characteristics and/or equipment status to a service provider may allow for timely intervention and servicing if the air quality decreases or if equipment requires servicing.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for improving indoor air quality in a human dwelling, comprising:
flowing air through an airflow conduit;
irradiating at least a portion of the air flowing through the airflow conduit with ultraviolet light;
turbulating at least a portion of the air flowing through the airflow conduit;
adjusting a humidity of at least a portion of the air flowing through the airflow conduit; and
filtering at least a portion of the air flowing through the airflow conduit.

2. The method of claim 1, further comprising creating an air pressure within the dwelling that exceeds an air pressure outside of the dwelling.

3. The method of claim 1, further comprising monitoring air quality characteristics of air flowing through the airflow conduit.

4. The method of claim 1, further comprising monitoring air quality characteristics of air flowing through the airflow conduit, wherein monitoring airflow characteristics comprises transmission of data to a remote site.

5. The method of claim 1, wherein a level of contamination in the air is reduced.

6. The method of claim 1, wherein a level of mold contamination in the air is reduced.

7. The method of claim 1, wherein filtering at least a portion of the air comprises electrostatic filtering.

8. A system for improving indoor air quality in a human dwelling, comprising:
an airflow conduit through which air flows;
an ultraviolet light source configured to irradiate at least a portion of the air flowing through the airflow conduit;
an air turbulator configured to turbulate at least a portion of the air flowing through the airflow conduit;
at least one humidity control unit configured to adjust a humidity of at least a portion of the air flowing through the airflow conduit; and
at least one filter configured to filter at least a portion of the air flowing through the airflow conduit.

9. The system of claim 8, further comprising a blower configured to transfer air into the dwelling to create an air pressure within the dwelling that exceeds an air pressure outside of the dwelling.

10. The system of claim 8, further comprising at least one sensor within the airflow conduit to monitor at least one air quality characteristic of air in the airflow conduit.

11. The system of claim 8, wherein a wavelength of the ultraviolet light is in a range from about 200 nanometers to about 280 nanometers.

12. The system of claim 8, wherein at least one filter comprises an electrostatic filter.

13. The system of claim 8, wherein at least one filter comprises a HEPA filter.

14. The system of claim 8, wherein a level of contamination in the air is reduced.

15. The system of claim 8, wherein a level of mold contamination in the air is reduced.

16. A method for improving indoor air quality in a human dwelling, comprising:
flowing air through an airflow conduit;
irradiating at least a portion of the air flowing through the airflow conduit with ultraviolet light; and
adjusting a humidity of at least a portion of the air flowing through the airflow conduit.

17. The method of claim 16, further comprising turbulating at least a portion of the air flowing through the airflow conduit.

18. The method of claim 16, further comprising creating an air pressure within the dwelling that exceeds an air pressure outside of the dwelling.

19. The method of claim 16, further comprising filtering at least a portion of the air flowing through the airflow conduit.

20. The method of claim 16, further comprising electrostatically filtering at least a portion of the air flowing through the airflow conduit.

21. The method of claim 16, further comprising monitoring air quality characteristics of air flowing through the airflow conduit.

22. The method of claim 16, further comprising monitoring air quality characteristics of air flowing through the airflow conduit, wherein monitoring air quality characteristics comprises transmission of data to a remote site.

23. The method of claim 16, wherein a level of contamination in the air is reduced.

24. The method of claim 16, wherein a level of mold contamination in the air is reduced.

25. A system for improving indoor air quality in a human dwelling, comprising:
an airflow conduit through which air flows;
an ultraviolet light source configured to irradiate at least a portion of the air flowing through the airflow conduit; and
at least one humidity control unit configured to adjust a humidity of at least a portion of the air flowing through the airflow conduit.

26. The system of claim 25, wherein a wavelength of the ultraviolet light is in a range from about 200 nanometers to about 280 nanometers.

27. The system of claim 25, further comprising at least one filter configured to filter at least a portion of the air flowing through the airflow conduit.

28. The system of claim 25, further comprising at least one electrostatic filter configured to filter at least a portion of the air flowing through the airflow conduit.

29. The system of claim 25, further comprising at least one HEPA filter configured to filter at least a portion of the air flowing through the airflow conduit.

30. The system of claim 25, further comprising an air turbulator configured to turbulate at least a portion of the air flowing through the airflow conduit.

31. The system of claim 25, further comprising a blower configured to transfer air into the dwelling to create an air pressure within the dwelling that exceeds an air pressure outside of the dwelling.

32. The system of claim 25, further comprising at least one sensor within the airflow conduit to monitor at least one air quality characteristic of air in the airflow conduit.

33. The system of claim 25, wherein a level of contamination in the air is reduced.

34. The system of claim 25, wherein a level of mold contamination in the air is reduced.

35. A method for improving indoor air quality in a human dwelling, comprising:
flowing air through an airflow conduit;
irradiating at least a portion of the air flowing through the airflow conduit with ultraviolet light; and
creating an air pressure within the dwelling that exceeds an air pressure outside of the dwelling.

36. The method of claim 35, further comprising turbulating at least a portion of the air flowing through the airflow conduit.

37. The method of claim 35, further comprising adjusting a humidity of at least a portion of the air flowing through the airflow conduit.

38. The method of claim 35, further comprising filtering at least a portion of the air flowing through the airflow conduit.

39. The method of claim 35, further comprising electrostatically filtering at least a portion of the air flowing through the airflow conduit.

40. The method of claim 35, further comprising monitoring air quality characteristics of air flowing through the airflow conduit.

41. The method of claim 35, further comprising monitoring air quality characteristics of air flowing through the airflow conduit, wherein monitoring air quality characteristics comprises transmission of data to a remote site.

42. The method of claim 35, wherein a level of contamination in the air is reduced.

43. The method of claim 35, wherein a level of mold contamination in the air is reduced. 44. A system for improving indoor air quality in a human dwelling, comprising:
an airflow conduit through which air flows;
an ultraviolet light source configured to irradiate at least a portion of the air flowing through the airflow conduit; and
a blower configured to transfer air into the dwelling to create an air pressure within the dwelling that exceeds an air pressure outside of the dwelling.

45. The system of claim 44, wherein a wavelength of the ultraviolet light is in a range from about 200 nanometers to about 280 nanometers.

46. The system of claim 44, further comprising a turbulator configured turbulate at least a portion of the air flowing through the airflow conduit.

47. The system of claim 44, further comprising a filter configured to filter at least a portion of the air flowing through the airflow conduit.

48. The system of claim 44, further comprising an electrostatic filter configured to filter at least a portion of the air flowing through the airflow conduit.

49. The system of claim 44, further comprising at least one humidity control unit configured to adjust a humidity of at least a portion of the air flowing through the airflow conduit.

50. The system of claim 44, further comprising at least one sensor in the airflow conduit to monitor at least one air quality characteristic of air in the airflow conduit.

51. The system of claim 44, wherein a level of contamination in the air is reduced.

52. The system of claim 44, wherein a level of mold contamination in the air is reduced.
